(19) United States
(12) Patent Application Publication
(10) Pub. No.: US 2006/0130353 A1
(43) Pub. Date: Jun. 22, 2006

(54) Centrifugal pellet dryer screen

(76) Inventor: Michael Eloo, Xanten (DE)

Correspondence Address: JACOBSON HOLMAN PLLC, 400 SEVENTH STREET N.W., SUITE 600, WASHINGTON, DC, 20004, US

(21) Appl. No.: 11/017,216

(22) Filed: Dec. 21, 2004

(51) Int. Cl. F26B 17/24; F26B 17/30

(52) U.S. Cl. 34/58; 34/175

(57) ABSTRACT

A centrifugal pellet dryer screen especially adapted for drying micropellets includes an exterior or outer support screen in the form of a cylindrical perforated plate, an inner screen of small wire mesh material, and an optional middle screen of wire mesh material sandwiched between the outer support screen and the inner screen. The screen layers are preferably diffusion bonded to each other. These multi-layer screens produce drier micropellets exiting the dryer and reduce banding of the micropellets and plugging of the dryer screen outlet holes.

### BACKGROUND OF THE INVENTION

1. Field of the Invention

The present invention relates generally to a screen incorporated into a centrifugal pellet dryer for drying pellets produced by an underwater pelletizer that enter the dryer as a water and pellet slurry. More specifically, the present invention relates to a centrifugal pellet dryer and dryer screen particularly useful for drying polymer micropellets.

The dryer screen of this invention includes an exterior or outer support screen in the form of a cylindrical perforated plate, an optional middle screen of wire mesh material and an inner screen of smaller wire mesh material. The outer support plate and middle and inner screens are bonded together in concentric contacting relation. The screen is supported in a centrifugal pellet dryer and functions in a manner similar to that disclosed in U.S. Pat. No. 6,237,244, issued May 29, 2001, having common ownership with this application and which is expressly incorporated herein by reference as if fully set forth.

2. Description of the Prior Art

Prior art centrifugal pellet dryers utilizing a mesh type screen or perforated plate type screen operate effectively when the pellets being dried have a diameter substantially greater than micropellets. Typical prior art screens are self-supporting single sheets generally in the form of a cylindrical screen sheet or plate with either circular holes or slotted holes. The screen sheet or plate is typically perforated in a flat condition and then rolled into the cylindrical screen shape.

In one typical embodiment of a prior art dryer screen produced by the assignee of this application, 20 gauge sheet metal is punched with round holes 0.075 inches (1.9 mm) in diameter resulting in a 50% open area, while still remaining self-supporting. Open area is defined as that area of the screen which is open for water, moisture or air to flow therethrough. Efforts to form smaller holes by punching the sheet metal result in the punches which form the holes breaking off. The smallest diameter holes that can be successfully punched is generally in the range of 0.062 inch ( 1/16 inch) but the use of such small punches reduces the open area to well below 50%. Such known prior art screens also tend to plug up and essentially form a smooth internal surface with very little drag on the pellets engaging the interior of the screen. The smooth surface causes the pellets to move or band in a circular path rather than moving axially upwardly and radially under the action of the inclined blades of the driving rotor in the dryer.

There are known prior art screens for use in drying polymer micropellets produced in an underwater pelletizer. Polymer micropellets are very small thermoplastic or other polymer pellets, having a diameter or outside dimension less than 0.050 inches (1.3 mm). In known screens for drying such micropellets, the sheet or plate is first formed into a cylindrical shape and the holes are then formed therein, such as by laser cutting or the like. Laser perforating the holes, however, results in a very smooth interior surface, thus exacerbating the problem of the pellets simply rotating around the interior of the screen without moving upwardly therein and thereby increasing the tendency of the screen holes or perforations to become plugged by pellets.

When round holes are used in the prior art polymer micropellet screens, such as in a 22 gauge screen, the holes preferably are approximately 0.40 mm in diameter which produces a retained open area of only about 8.5%. When slotted holes are used, the 22 gauge screen is formed with slots that are typically 0.40 mm in height and 4 mm in length which provides approximately a 14% open area. However, screens with slotted holes tend to crack or tear during use in the centrifugal dryer.

Drying polymer micropellets in centrifugal dryers has become very difficult using known prior art screens. Because polymer micropellets have a tendency to band around the inner surface of the cylindrical screen, especially when the inner surface is smooth or otherwise not interrupted, the micropellets simply circulate around the inside of the screen, plugging the screen holes, and do not move axially, upwardly with rotation of the dryer rotor. The micropellets move up only through the forced introduction of more micropellets into the dryer inlet. As a result, centrifugal pellet dryers have heretofore been generally ineffective in drying polymer micropellets. Hence, there is a need for a centrifugal dryer screen which will overcome the banding and plugging problems and provide for effective drying of polymer micropellets in a centrifugal dryer.

### DESCRIPTION OF THE INVENTION

The micropellet dryer screen constructed in accordance with the present invention comprises a multi-layer laminated dryer screen including an outer cylindrical support screen and an inner mesh screen having irregular, rough surfaces. A middle mesh screen also having irregular rough surfaces is preferably sandwiched between the inner mesh screen and the outer support screen. The inner mesh screen and optional middle mesh screen are both preferably a woven wire screen, most preferably a woven wire screen having a Dutch Weave or Bolting Cloth configuration.

The outer support screen is typically formed from sheet metal which has been perforated by punching or the like to form the holes therein. The sheet metal is then formed into a cylindrical shape or plate which has the necessary thickness and rigidity to make the multilayer screen of the present invention self-supporting. Solid, non-perforated reinforcement bands are preferably attached at the outer ends of the cylindrical outer plate or screen to reinforce the top and bottom of the multilayer screen. The thickness of the outer support screen can range between 18 gauge (about 0.05 inches) and 22 gauge (about 0.0312 inches). Outer support screens made from 22 gauge (0.0312 inches) and 20 gauge (0.0375 inches) stainless steel sheet material have been found suitable for the present invention. The hole sizes can range between about 0.038 inches to about 0.1875 inches, preferably about 0.075 inches to about 0.1875 inches, in diameter. The open area of the outer support screen should be at least about 25% to about 30%, and preferably about 50%, or more.

In the preferred 3-layer dryer screen in accordance with the present invention, the mesh size, i.e. the number of openings per square inch, of the middle mesh screen can range from about 20 mesh (a 0.0331 inch size opening) to about 50 mesh (0.0117 inches), preferably about 25 mesh (0.0280 inches) to about 35 mesh (0.0197 inches) and most preferably about 30 mesh (0.0232 inches). The middle mesh screen preferably has a Dutch Weave wire screen configuration. The mesh size of the inner mesh screen can be as low as 50 mesh (0.0117 inches) and as high as 150 mesh (0.0040 inches), preferably about 60 mesh (0.0098 inches) to about 90 mesh (0.0065 inches), and most preferably about 70 mesh (0.0083 inches) The inner mesh screen preferably has a Bolting Cloth wire screen configuration.

In the 2-layer dryer screen in accordance with the present invention, the mesh size of the inner screen is the same as for the 3-layer screen of the present invention. More specifically, the mesh size of the inner mesh screen can be as low as 50 mesh (0.0117 inches) and as high as 150 mesh (0.0040 inches), preferably about 60 mesh (0.0098 inches) to about 90 mesh (0.0065 inches), and most preferably about 70 mesh (0.0083 inches). The Bolting Cloth wire screen configuration is also preferred for the inner mesh screen of a 2-layer dryer screen in accordance with the present invention.

The adjacent screens, whether in 3-layers or 2-layers, preferably have their surfaces bonded together. These surfaces are also preferably bonded throughout their full surface areas, rather than attached only at spots, such as by spot welding or brazing, although spot attachment can be utilized in some circumstances. Most preferably, the adjacent surfaces of the multi-layered screens are diffusion bonded at all adjacent contact surface areas. This attaching mechanism reduces the tendency of the inner screen to slip or wrinkle with respect to the outer supporting screen or plate in the 2-layer form, or with respect to the middle screen in the 3-layer form, during operation of the centrifugal dryer. Manufacturers of diffusion bonded multi-layer screen materials which may be useful for the present invention are Omni Filter & Manufacturing, Inc. of Ashland, Va. and Purolator Facet, Inc. of Greensboro, N.C.

It has been surprisingly found that the multi-layer dryer screens of the present invention result in self-supporting dryer screens which can have very small inner screen openings that will retain the smallest polymer micropellets within the screen enclosure. At the same time, the multi-layer dryer screens of the present invention provide a high percentage of open area to allow water to pass out of the dryer screen at a higher rate. Typically, the total open area of multilayer dryer screens in accordance with the present invention should have an open area in the neighborhood of about 30%, or more.

It has also been found that the alternating recesses and ridges or undulations of the wire mesh materials cause the pellets to bounce radially inwardly in a random fashion when impacting against the inner surface of the screen. This random inward movement or bouncing of the pellets allows the rotating inclined blades on the rotor to more effectively elevate the pellets and to more effectively direct the pellets outwardly for continued impacting engagement with the irregular surfaces of the inner screen. This recirculation of the pellets radially inwardly and outwardly in relation to the screen produces a more effective removal of surface water or moisture from the pellets and discharge of such moisture through the screen, while retaining the micropellets interiorly of the screen and moving the pellets axially upwardly within the screen.

In addition, the multi-layer dryer screens of the present invention surprisingly result in drier polymer micropellets, i.e., less surface moisture, exiting the centrifugal dryer. While intending not to be bound by any theoretical explanation, it is believed that the drier micropellets exiting the dryer are a direct result of the irregular surface of the dryer inner screen, which produces a more effective removal of the surface water or moisture from the pellets, and the high percentage of screen open area, in the neighborhood of 30%, as stated above. The high percentage of open area permits a greater volume of air to flow into the pellet discharge outlet and then through the screen. This increased air flow further assists in removing the surface water or moisture from the pellets as they rise inside the screen and air flows through the pellets entrained therein.

Accordingly, it is an object of the present invention to provide a screen for a centrifugal pellet dryer especially useful for drying polymer micropellets which includes an outer substantially self-supporting cylindrical perforated sheet or plate combined with at least one inner screen of wire mesh material; the inner screen has very small openings to retain the polymer micropellets within the interior of the screen while enabling passage of surface water or moisture from the pellets out through the screen during rotation of the dryer rotor.

A further object of the present invention is to provide a multi-layer dryer screen in accordance with the preceding object which dries the pellets, especially polymer micropellets, to a lower percentage of moisture when they are discharged from the centrifugal dryer.

Another object of the present invention is to provide a polymer micropellet screen for a centrifugal dryer in which the inner screen is provided with an irregular, rough interior surface to cause random radial movement of the micropellets for more effective removal of moisture and to eliminate the tendency of polymer micropellets to band and move in generally a circular path around an otherwise smooth surface on the interior screen surface.

Still a further object of the present invention is to provide a dryer screen in accordance with the preceding object in which the plugging of the screen openings is substantially reduced as a result of the irregular, rough interior surface of the inner screen.

Still another object of the present invention is to provide a dryer screen in accordance with the preceding objects in which the screen includes a plurality of concentric screens having a high open area to provide maximum air flow from the pellet discharge opening through the pellets and screen for a more effective drying of the pellets during their movement upwardly within the screen.

Yet a further object of the present invention is to provide a multi-layered dryer screen in which the screen layers are diffusion bonded throughout their full surface areas to reduce the tendency of the inner screen to slip or wrinkle during operation of the centrifugal dryer for more effectively retaining small pellets within the screen.

Yet another object of the present invention is to provide a multi-layered dryer screen in which the inner surface of the inner screen is irregular, rough, undulated or provided with ridges and valleys to reduce the tendency of pellets, especially polymer micropellets, to band along the inner surface in a circular path rather than moving axially upwardly and radially inwardly and outwardly by the inclined blades on the dryer rotor.

A final object of this invention to be specifically enumerated herein is to provide a multi-layered dryer screen in accordance with the preceding objects which will conform to conventional forms of manufacture, be of simple construction and easy to use so as to provide a centrifugal pellet dryer screen that will be economically feasible, strong and long lasting and relatively trouble free in installation and use.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic sectional view of one type of existing centrifugal pellet dryer, similar to FIG. 1 in U.S. Pat. No. 6,237,244, illustrating a screen associated with the operational components of the dryer.

FIG. 2 is a perspective view of a dryer screen in accordance with the present invention for use in polymer micropellet production.

FIG. 3 is a partial elevational view, on an enlarged scale, of a 3-layer micropellet dryer screen in accordance with the present invention, illustrating a wire mesh inner screen diffusion bonded to a wire mesh middle screen which, in turn, is diffusion bonded within a cylindrical perforated plate forming an outer screen.

FIG. 4 is a further enlarged view of a segment of the screen of FIG. 3, illustrating the details of the wire mesh inner and middle screens within the perforated plate outer screen.

FIG. 5 is a partial elevational view, on an enlarged scale, of a segment of another 3-layer micropellet dryer screen, illustrating the outer perforated plate, middle wire mesh screen and inner wire mesh screen diffusion bonded to each other throughout their surface areas.

FIG. 6 is an enlarged view of a segment of the screen of FIG. 5 illustrating details of the wire mesh screens inside the perforated outer plate.

FIG. 7 is a fragmental elevational view of a segment of a 3-layer micropellet dryer screen constructed in accordance with the present invention.

FIG. 8 is a sectional view taken along line 8-8 of FIG. 7.

FIG. 9 is a sectional view similar to FIG. 8, but illustrating a 2-layer screen having an outer screen in the form of a cylindrical perforated plate and an inner wire mesh screen.

### DESCRIPTION OF PREFERRED EMBODIMENTS

Although several preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways. Also, in describing preferred embodiments, specific terminology will be resorted to for the sake of clarity. It is to be understood that each specific term includes all technical equivalents which operate in a similar manner to accomplish a similar purpose.

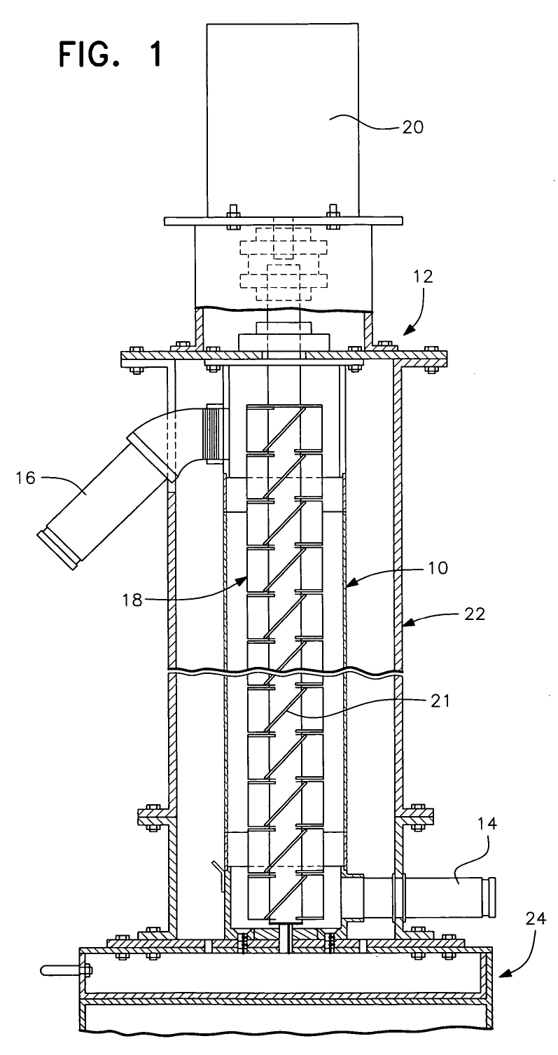

Referring specifically to the drawings, the polymer micropellet dryer screen of the present invention is generally designated by reference numeral 10. FIG. 1 discloses the association of the micropellet screen 10 within a typical centrifugal pellet dryer generally designated by reference numeral 12 that is disclosed in detail in the aforesaid U.S. Pat. No. 6,237,244. The centrifugal pellet dryer 12 includes a water and pellet slurry inlet 14 at its lower end and a dried pellet outlet 16 at its upper end. Inlet 14 communicates with the interior of the screen 10 near its lower end and the outlet 16 communicates with the screen 10 near its upper end. A rotor generally designated by reference numeral 18 is rotatably positioned within the screen 10 and is driven by a motor 20 drivingly connected to the rotor, shown at its upper end in the configuration of FIG. 1.

The rotor 18 includes inclined blades 21 rotating within the screen 10 to move the water and pellet slurry upwardly and to move the pellets and water radially outwardly into impacting engagement with the interior of the screen 10. The impact against the interior of the screen 10 causes water to be discharged outwardly of the screen into a housing generally designated by reference numeral 22 for downward gravity discharge, such as into a water tank generally designated by reference numeral 24. Essentially, the micropellet screen 10 of the present invention can be utilized in combination with the foregoing components of the centrifugal dryer as shown in the aforementioned U.S. patent or any other centrifugal pellet dryer which can accommodate the screen of the present invention and serve to dry pellets, especially polymer micropellets.

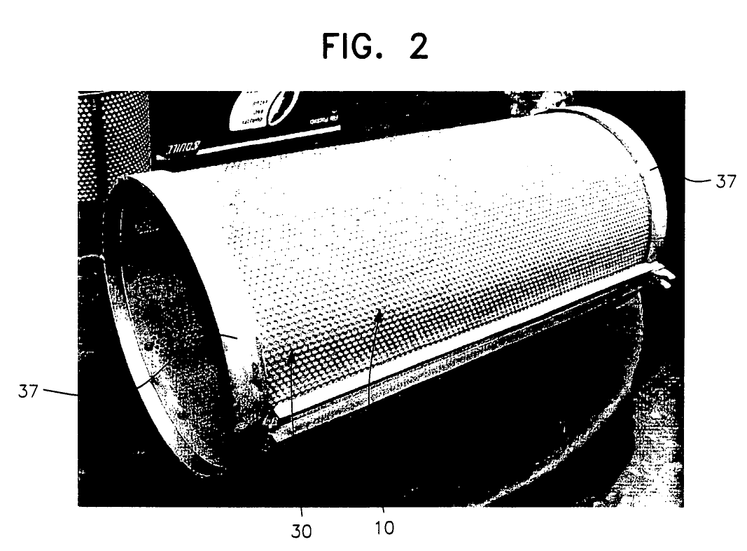

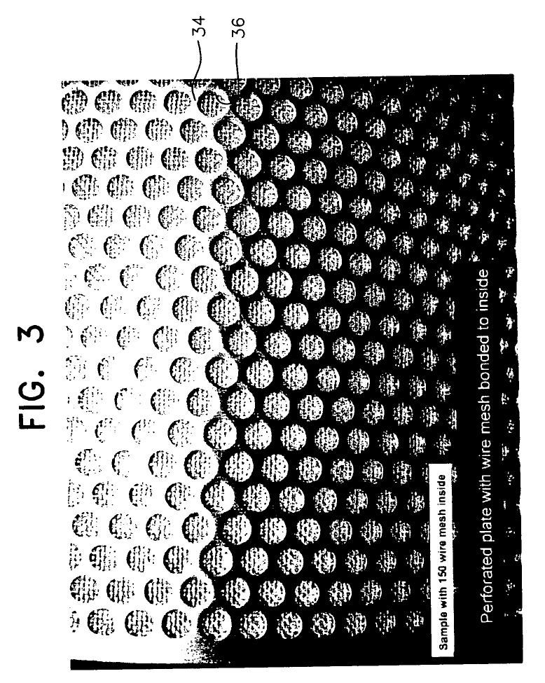

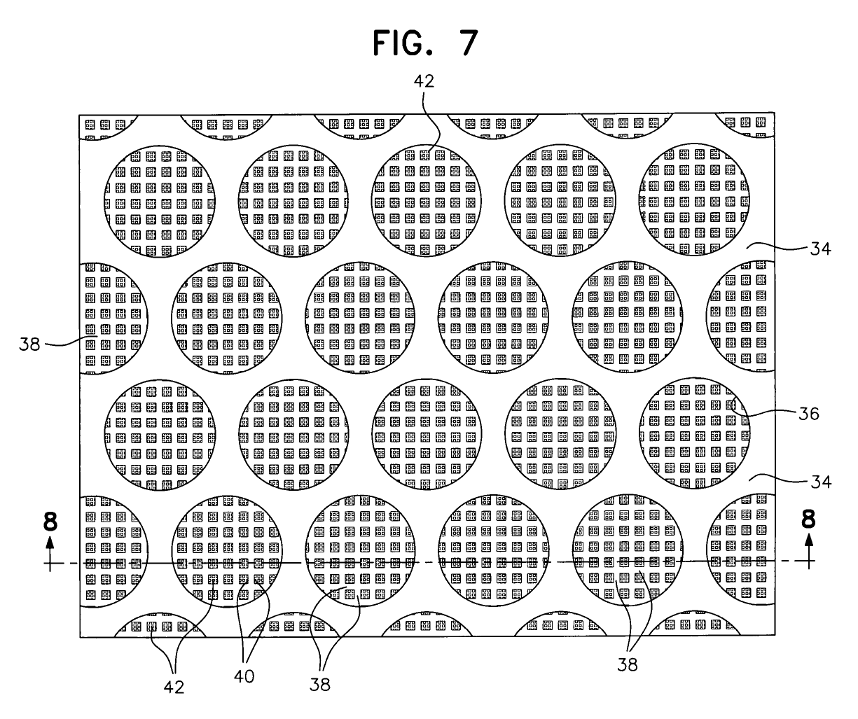

As illustrated in FIG. 2, multi-layer screen 10 includes an outer screen, generally designated by reference numeral 30 in the form of a cylindrical metal plate 34 made from perforated sheet metal, preferably stainless steel. The plate 34 has a plurality of perforations or holes 36 therein as illustrated in more detail in FIGS. 3-8. The screen 10 preferably has solid, stainless steel reinforcing bands 37 attached to the outer ends of the plate 34. The plate 34 and bands 37 have sufficient rigidity to maintain the desired self-supporting cylindrical shape for the screen 10. The bands 37 also serve as a support surface for holding the screen 10 in position within the dryer housing 22.

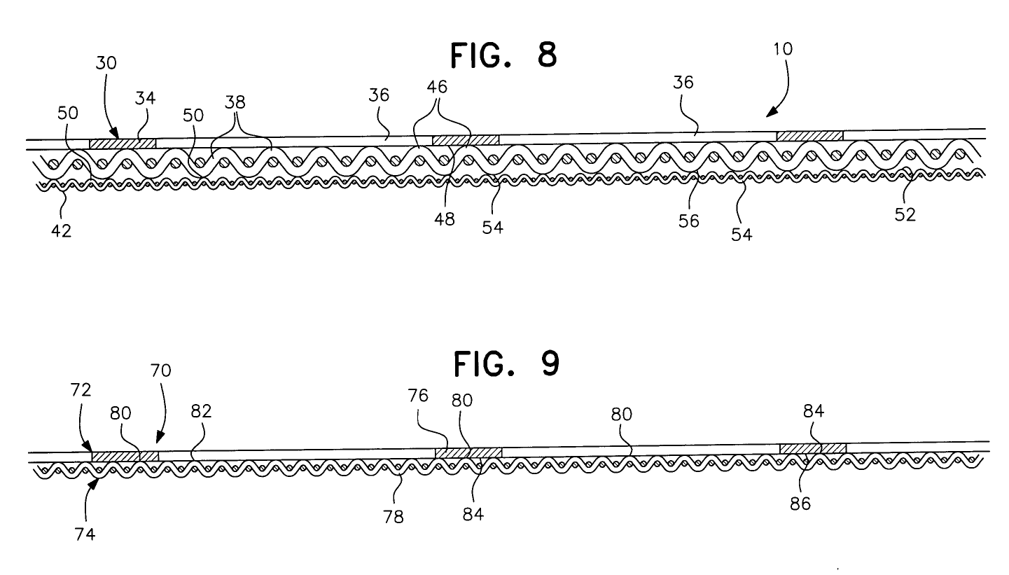

A middle screen 38 of wire mesh material is engaged with and fusion bonded, preferably diffusion bonded throughout its outer contact surfaces, to the inner surface 48 of the outer perforated metal plate 34. (See FIG. 8). The middle screen 38 includes openings 40 therethrough which are much smaller in size than the openings 36 in the outer plate 34. Fusion bonded to the inside of the middle screen 38 is an inner screen 42 also of a wire mesh material. More specifically, the contacting surface areas 50 of the outer side 52 of the inner screen 42 are diffusion bonded to the contacting surface areas 54 of the inner side 56 of middle screen 38. The wire mesh material for the middle screen 38 is preferably Dutch Weave woven wire metal screen and for the inner screen, preferably Bolting Cloth wire metal screen.

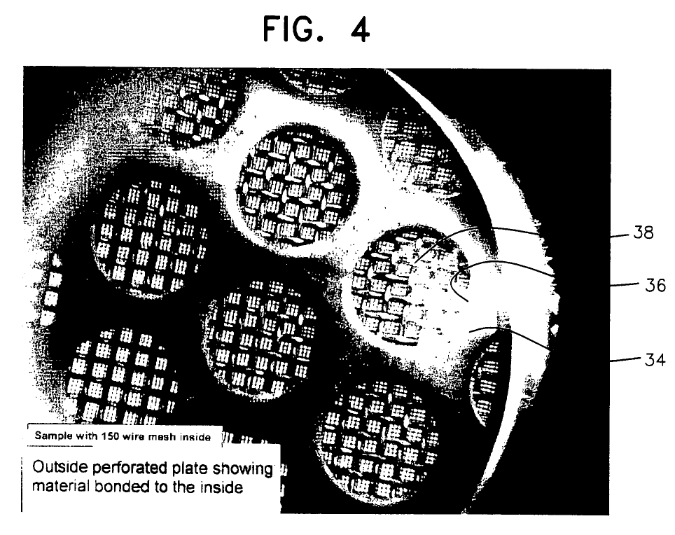

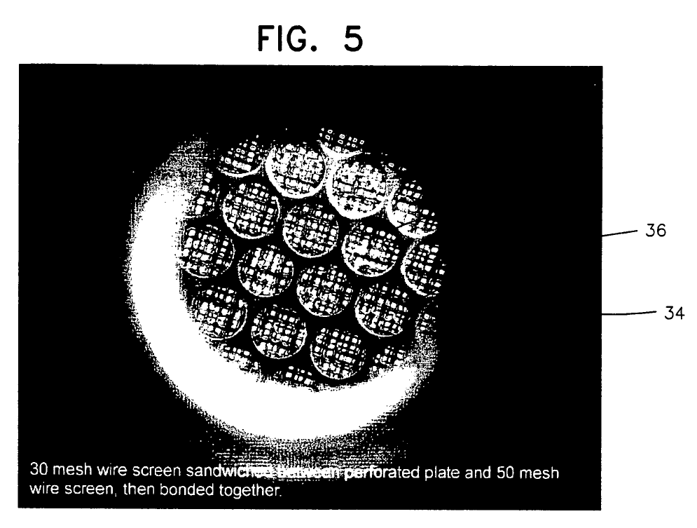

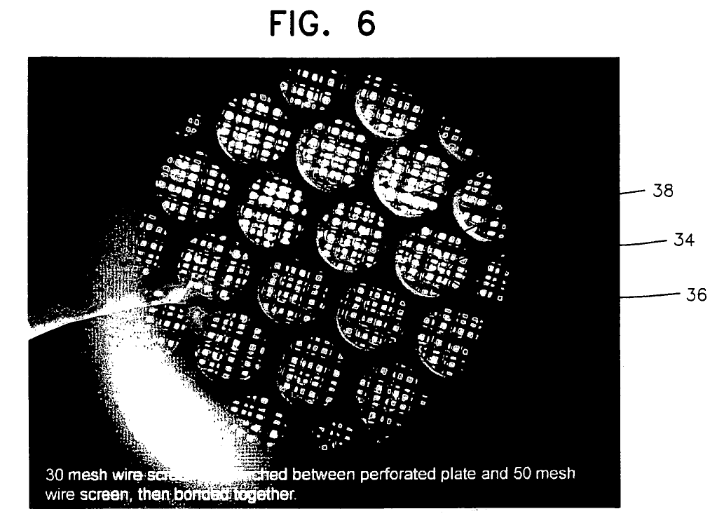

FIGS. 3 and 4 illustrate a screen 10 in which the perforated plate 34 of the outer screen 30 is made of 20 gauge stainless steel having holes approximately 0.1875 inches in diameter. Fusion bonded to the inside of the plate 34 is a 30 mesh Dutch Weave wire middle screen 38, and fusion bonded to the inside of middle screen 38 is a 150 mesh Bolting Cloth wire inner screen 42. FIGS. 5 and 6 illustrate another screen 10 constructed in 10 accordance with the present invention in which the perforated plate 34 of outer screen 30 is made of 20 gauge stainless steel having holes approximately 0.1875 inches in diameter. Fusion bonded to the inside of the plate 34 is a 30 mesh Dutch Weave wire middle screen 38, and fusion bonded to the inside of middle screen 38 is a 50 mesh Dutch weave wire inner screen 42. These examples clearly illustrate the differences between an inner screen of 150 mesh as shown in FIGS. 3 and 4 and an inner screen of 50 mesh as shown in FIGS. 5 and 6.

FIG. 9 illustrates a 2-layer dryer screen in accordance with the present invention, generally designated by reference numeral 70. Dryer screen 70 includes an outer screen generally designated by reference numeral 72 and an inner screen generally designated by reference numeral 74. The outer screen 72 is in the form of a cylindrical metal plate 76, similar to cylindrical metal plate 34 of FIGS. 2-8. The inner screen 74 is preferably a wire mesh screen 78 having the requisite irregular, rough, undulating inner surface to repel micropellets in random directions when impacted against the inner surface of the screen 74. As with the 3-layer screen of FIGS. 2-8, the contacting surface areas 80 of the outer side 82 of the inner wire mesh screen 78 are fusion bonded to the contact surface areas 84 on the inside surface 86 of the perforated plate 72.

While bonding the inner screen 74 to the outer screen 72 is clearly preferred in a 2-layer dryer screen, it may not be necessary to bond the wire mesh inner screen 74 to the outer perforated plate 72 in smaller sized screens, such as screens having an 8-inch diameter or less. It may be possible to simply insert the inner screen 74 inside the outer screen 72, so long as the inner screen 74 has sufficient resilience or springiness toward returning to its flat shape so that it remains pressed against the inner surface 86 of the outer screen 72.

In the 3-layer configuration for the dryer screen 10 of the present invention, the perforated plate 34 of the outer screen 30 can be constructed of sheet metal having a thickness ranging from as low as 18 gauge to as high as 22 gauge, preferably between about 22 gauge and about 20 gauge. The mesh size of the middle mesh wire screen 38 can range from about 20 mesh to about 50 mesh, preferably about 25 mesh to about 35 mesh, and most preferably about 30 mesh. The mesh size of the inner mesh wire screen 42 can be as low as 50 mesh and as high as 150 mesh, preferably about 60 mesh to about 90 mesh, and most preferably about 70 mesh. Both the middle mesh wire screen 38 and inner mesh wire screen 42 preferably have a Dutch Weave or Bolting Cloth configuration.

In the 2-layer configuration for the dryer screen 10 of the present invention, the perforated plate of the outer screen 72 can be constructed of sheet metal having a thickness ranging from as low as 22 gauge to as high as 18 gauge, preferably about 22 gauge to about 20 gauge. The mesh size for the inner mesh wire screen is the same as in the 3-layer configuration. Again, Dutch Weave or Bolting Cloth is the preferred configuration for the inner mesh wire screen.

The multi-layer dryer screen of the present invention has been specifically described for 3-layer and 2-layer embodiments, with the 3-layer embodiment more preferred. It is believed that the middle layer in the 3-layer embodiment actually increases the open area of the dryer screen and serves as a drainage field for the water escaping through openings of the inner screen, thus providing for more rapid removal of the water and moisture during the drying operation. In addition, those skilled in the art will readily appreciate that 3-layers and 2-layers are preferred for the multi-layer screen of the present invention, but additional layers beyond three may be possible, such as four layers, if desired.

While the centrifugal pellet dryer screen of the present invention has been described as especially useful for drying polymer micropellets, the dryer screen of the present invention can be useful in drying other size and type pellets particularly where the pellets being dried have a tendency to band and circulate around the screen, rather than moving axially up the screen towards the dryer exit, or otherwise tend to plug the screen holes. One such material for which the dryer screen of the present invention can be particularly applicable is expandable polystyrene pellets in process line dryers. Other materials could include EPS reactor beads, which are very small pellets down to sizes as low as 0.2 mm, and other small size pellets or materials, including fines and fine particles in general regardless of how they are made.

The foregoing is considered as illustrative only of the principals of the invention. Further, numerous modifications and changes will readily occur to those skill in the art. Therefore, it is not intended to limit the invention to the exact construction and operation shown and described, and all suitable modifications and equivalents may be resorted to, falling within the scope of the invention.

What is claimed:

1. A screen for a centrifugal pellet dryer when used to dry polymer micropellets or other small pellets introduced into the dryer as a slurry of water and pellets, said screen comprising a generally cylindrical perforated shape sustaining outer member and at least one inner wire mesh screen conforming with and attached to an inner surface of said outer member, said inner wire mesh screen having closely spaced openings small enough to retain polymer micropellets or other small pellets interiorly of the inner screen and permitting passage of water through the inner screen and outer member during operation of the centrifugal pellet dryer.

2. The dryer screen as claimed in claim 1, wherein said closely spaced openings maintain a high open area in the inner screen to enable increased water flow through the screen and to reduce plugging of said inner screen openings by retained micropellets.

3. The dryer screen as claimed in claim 1, wherein said closely spaced openings have a maximum dimension of about 0.40 mm to retain said micropellets or other small pellets having minimum dimensions greater than about 0.40 mm.

4. The dryer screen as claimed in claim 1, wherein said wire mesh inner screen is bonded to said outer member and provides a rough surface engaged by the micropellets or other small pellets to resist banding and facilitate upward and radial movement of the micropellets or other small pellets within the screen by rotation of a rotor during operation of the dryer.

5. The dryer screen as claimed in claim 1, wherein said closely spaced openings in the inner screen and the perforated outer member form a open area of about 30% of the surface area of the screen.

6. The dryer screen as claimed in claim 1, wherein said inner wire mesh is a woven wire mesh screen bonded to an inner surface of said outer member.

7. The dryer screen as claimed in claim 6, wherein said woven wire mesh screen is diffusion bonded substantially throughout its contact surfaces to inner contact surfaces of said outer member.

8. The dryer screen as claimed in claim 1, wherein the outer ends of said screen include unperforated generally cylindrical reinforcing bands.

9. The dryer screen as claimed in claim 1, wherein a second wire mesh screen is sandwiched between and diffusion bonded to said inner wire mesh screen and said generally cylindrical perforated outer member.

10. The dryer screen as claimed in claim 9, wherein said second wire mesh screen has openings larger than the closely spaced openings of said inner wire mesh screen.

11. A centrifugal pellet dryer for drying polymer micropellets and other small pellets which comprises a housing, a cylindrical screen mounted generally vertically in said housing, a water and pellet slurry inlet adjacent a bottom of said cylindrical screen and a dried pellet outlet adjacent a top of said cylindrical screen, and a driven rotor to direct said pellets entering said inlet outwardly towards said cylindrical screen and upwardly towards said outlet, said generally cylindrical screen being multi-layered and having at least a generally cylindrical perforated shape sustaining outer member and a wire mesh inner screen conforming with and attached to an inner surface of said outer member, said wire mesh screen having a wire mesh size sufficient to retain said pellets interiorly of the screen and permitting passage water through the inner screen and outer member during operation of the centrifugal pellet dryer.

12. The centrifugal pellet dryer as claimed in claim 11, wherein said screen and said perforated shape sustaining outer member are both generally cylindrical.

13. The centrifugal pellet dryer as claimed in claim 11, wherein said generally cylindrical screen has an open area in the neighborhood of about 30% to enable increased water flow through the screen and to reduce plugging of said inner screen openings by retained pellets.

14. The centrifugal pellet dryer as claimed in claim 11, wherein openings of said wire mesh inner screen have a maximum dimension of about 0.40 mm.

15. The centrifugal pellet dryer as claimed in claim 11, wherein said wire mesh inner screen provides a rough surface for engagement with said pellets to resist banding and facilitate upward and radial movement of said pellets within said screen by rotation of said rotor during operation of the dryer.

16. The centrifugal pellet dryer as claimed in claim 11, wherein ends of said generally cylindrical screen include solid generally cylindrical bands for reinforcing said screen and facilitating attachment of said screen in said dryer.

17. The centrifugal pellet dryer as claimed in claim 11, wherein an outer surface of said wire mesh inner screen is bonded to an inner surface of a middle screen and an outer surface of said middle screen is bonded to an inner surface of said cylindrical perforated outer member.

18. The centrifugal pellet dryer as claimed in claim 17, wherein all of said surfaces are diffusion bonded substantially throughout their contact surfaces.

19. A generally cylindrical screen for a centrifugal pellet dryer when used to dry polymer micropellets introduced into the dryer as a slurry of water and pellets, said generally cylindrical screen comprising three layers, including a generally cylindrical perforated shape sustaining outer member, a wire mesh middle screen whose outer surface is diffusion bonded substantially throughout its contact surfaces to inner contact surfaces of said outer member, and a wire mesh inner screen conforming with and having its outer surface diffusion bonded substantially throughout its contact surfaces to inner contact surfaces of said middle screen, said wire mesh inner screen having openings smaller than openings of said wire mesh middle screen and sufficient to retain said polymer micropellets interiorly of the inner screen while permitting passage of water through the inner screen, middle screen and outer member during operation of the centrifugal pellet dryer.

20. The dryer screen as claimed in claim 19, wherein said screen has an open area of about 30%.
